(19) United States
(12) Patent Application Publication
(10) Pub. No.: US 2012/0109583 A1
(43) Pub. Date: May 3, 2012

(54) Logistically Enabled Sampling System

(75) Inventors: Matthew Bartlett, Austin, TX (US); Brian Schimmoller, Austin, TX (US)

(73) Assignee: SIGNATURE SCIENCE, LLC, Austin, TX (US)

(21) Appl. No.: 13/099,588

(22) Filed: May 3, 2011

Related U.S. Application Data
(60) Provisional application No. 61/330,712, filed on May 3, 2010.

(51) Int. Cl. G06F 15/00; G01N 1/22

(52) U.S. Cl. 702/187

(57) ABSTRACT

In accordance with one embodiment of the present invention, a data acquisition and control system includes a sample manifold for collecting air samples. The manifold may include twenty-eight discrete sorbent tubes. Each sorbent tube may be sealed within the manifold and the manifold may be removed from the system for sorbent tube analysis. A second manifold may be connected to the system for continued air sampling collection. The system may autonomously collect multiple samples at scheduled or triggered events. The system may also communicate with other systems to form a multi-system monitoring network. The system may also interface and operate with a multitude of sensors and monitors of different types.

### PRIORITY STATEMENT UNDER 35 U.S.C. §119 & 37 C.F.R. §1.78

This non-provisional application claims priority based upon prior U.S. Provisional Patent Application Ser. No. 61/330,712 filed May 3, 2010 in the name of Brian J. Schimmoller, entitled “Logistically Enabled Sampling System,” the disclosure of which is incorporated herein in its entirety by reference. A Request for Correction of Inventorship was submitted after the initial filing of the provisional application to request that Matthew F. Bartlett is added as the first named inventor.

### BACKGROUND OF THE INVENTION

The present invention relates generally to sensor systems and networks and, more particularly, to air sampling systems.

The collection of air samples presents many complications. For instance, the distribution of collection points for air samples must often be spatially dense to detect air constituents, especially at trace levels. In addition, multiple collection points must typically be sampled simultaneously and with a high frequency. The detection and measurement of volatile organic compounds (“VOCs”) and other air toxics present considerable air sampling challenges due, for example, to their volatility and small concentration in ambient air. Unfortunately, due to factors such as these, the set-up, maintenance, staffing, and logistics costs of air sampling projects often exceed budgeting expectations. As a result, the scope of air sampling projects must often be restricted to meet limited budget requirements. In many cases, air sampling projects have fewer monitoring stations and lower-resolution data than is desired.

Air sampling to assess indoor air quality also presents difficult challenges, particularly when attempting to detect and measure contaminant vapor intrusion. Poor indoor air quality can cause serious health risks and other safety concerns, such as the danger of explosion. Often, the source of indoor air contamination is contaminant vapor intrusion into a building or other structure from proximate soil or ground water contamination. Assessment of contaminant vapor intrusion can be complicated by the complexity of vapor migration affected by factors such as source location, building design, and weather conditions.

Therefore, it can be appreciated that there is a significant need for a sampling system that simplifies the collection of densely-distributed, simultaneous, high-frequency samples. It can further be appreciated that there is a significant need for a sampling system that streamlines the deployment, modification and operation of multiple-station sampling networks. It can further be appreciated that there is a significant need for a sampling system that can operate as a stand-alone system, integrate with existing monitoring systems, and be supplemented with complementary sensors and measurement tools. It can further be appreciated that there is a significant need for a sampling system that offers a cost-effective, turn-key program, allowing the ability to cast a wider sampling net and get data more economically. It can further be appreciated that there is a significant need for accurate, reliable and sensitive techniques for monitoring trace levels of VOCs. Embodiments of the present invention can provide these and other advantages, as will be apparent from the flowing detailed description and accompanying figures.

### SUMMARY OF THE INVENTION

In accordance with one embodiment of the present invention, a data acquisition and control system includes a sample manifold for collecting air samples. The manifold may include twenty-eight discrete sorbent tubes. Each sorbent tube may be sealed within the manifold and the manifold may be removed from the system for sorbent tube analysis. A second manifold may be connected to the system for continued air sampling collection. The system may autonomously collect multiple samples at scheduled or triggered events. The system may also communicate with other systems to form a multi-system monitoring network. The system may also interface and operate with a multitude of sensors and monitors of different types.

### DESCRIPTION OF THE DRAWINGS

FIG. 1 shows a perspective cut-away view of the backside of one embodiment of the system of the present invention.

FIG. 2 shows a perspective view of one embodiment of a sampler assembly of the present invention with its cover removed.

FIG. 3 shows a perspective view of one embodiment of a sampler assembly of the present invention with its cover attached.

FIG. 4 shows an example of source attribution generated with one embodiment of the system of the present invention.

FIG. 5 shows an example map of multiple chemical parameters generated with one embodiment of the system of the present invention.

### DESCRIPTION OF THE PREFERRED EMBODIMENTS

In one embodiment, the present invention comprises a data acquisition and control system includes a sample manifold for collecting air samples. The manifold may include twenty-eight discrete sorbent tubes. Each sorbent tube may be sealed within the manifold, and the manifold may be removed from the system for sorbent tube analysis. A second manifold may be connected to the system for continued air sampling collection. The system may autonomously collect multiple samples at scheduled or triggered events. The system may also communicate with other systems to form a multi-system monitoring network. The system may also interface and operate with a multitude of sensors and monitors of different types.

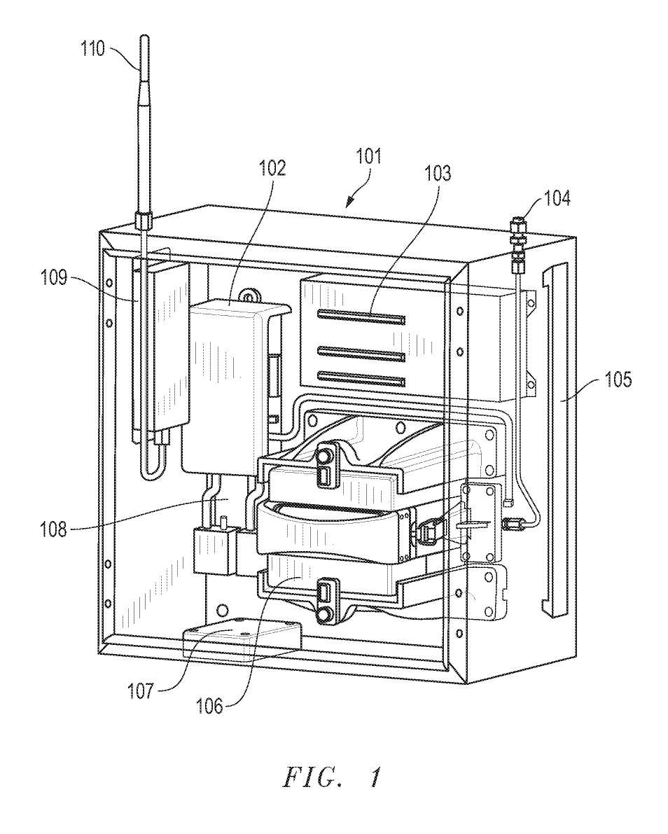

Reference is now made to FIG. 1, which shows a perspective cut-away view of the backside of one embodiment of the system of the present invention. In this embodiment, the system 101 includes a mass flow meter 102, a data logger/control module 103, a sample inlet connection 104, an enclosure 105, a sample manifold 106, a power supply 107, a sample pump 108, a communication module 109, and an antenna 110. In one embodiment, the sample inlet connection 104 may include a sample cane and a particulate filter. In one embodiment, the sample manifold 106 may include twenty-eight sample positions for sorbent tubes (not shown). The system 100 may be programmed to schedule sampling and data logging at desired frequencies. For example, the system 100 may be programmed to sample air for a wide range of chemical species on an hourly basis. In one embodiment, the entire sample manifold 106 can be removed and replaced with another sample manifold (not shown) without interrupting the programmed air sampling of the system 100. In this manner, multiple used sorbent tubes may be collected within a sealed removable sample manifold 106 and replaced with multiple new sorbent tubes in another removable sealed sample manifold.

The system 100 may also include expandable I/O ports for scalability of analog and digital sensors. The system 100 may also offer a flexible programming language for multiple control applications. In one embodiment, the enclosure 105 includes a key lock (not shown) and is approximately 15.75 inches by 15.75 inches by 8.81 inches. In one embodiment, the power supply 107 may be 120-240 VAC 50-60 Hz and, in another embodiment, it may be 12 VDC. In one embodiment, the system 100 may operate with low power requirements that allow for the system 100 to be, for example, placed in remote locations and powered by solar or a combination of solar and battery power. In one embodiment, the communication module 109 may include a means for a direct connection such as an Ethernet, RS-232, RS-485 or a fiber optic connection. In other embodiments, the communication module 109 may include a RF spread spectrum radio or a cellular transceiver. The system 100 may also interface with meteorological sensors, criteria pollutant monitors, calibration systems, and chemical sensors

Reference is now made to FIG, 2, which shows a perspective view of one embodiment of a sampler assembly 200 of the present invention. In this embodiment, the sampler assembly 200 includes a sample manifold 201 and a cover 202, which has been removed from the sample manifold 201. The sampler assembly 200 can be easily transported to the location of a system 100. The sample manifold 201 can then be inserted in the system 100 to collect data for subsequent analysis. For example, the sample manifold 201 of the sampler assembly 200 may be “hot-swapped” with a sample manifold 106 already in the system 100. For example, the sample manifold 106 may be removed from the system 100, the cover 202 may be removed from sample manifold 201, the sample manifold 201 may be inserted into the system 100, and the cover 202 may be placed onto the sample manifold 106, all without losing significant sampling time. The sample manifold 106 may then be shipped to a laboratory so that its sorbent tubes may be tested. The sample manifold 201 may also include a connector 203 for directly electronically connecting the sample manifold 201 to the data acquisition and control features of system 100. For example, the sample manifold 201 may be used to download data from the system 100 or upload sampling instructions to the system 100. In this embodiment, the sample manifold 201 also includes latches 204 that may connect to clasps 205 on the cover 202.

As mentioned above, the sample manifold 201 of the sampler assembly 200 may be “hot-swapped” with a sample manifold 106 already in the system 100. This functionality can provide numerous benefits. For example, hot-swapping one manifold maintains the integrity of both the manifold that has been removed and the replacement manifold which, when the manifold is sealed in a tamper-proof configuration at the laboratory, ensures the integrity of the sample. This can be valuable, for example, when providing sample data in connection with litigation or other legal proceedings. In certain embodiments, the manifold has no discrete pneumatic or electronic connections, thereby simplifying the process by which the operator swaps manifolds.

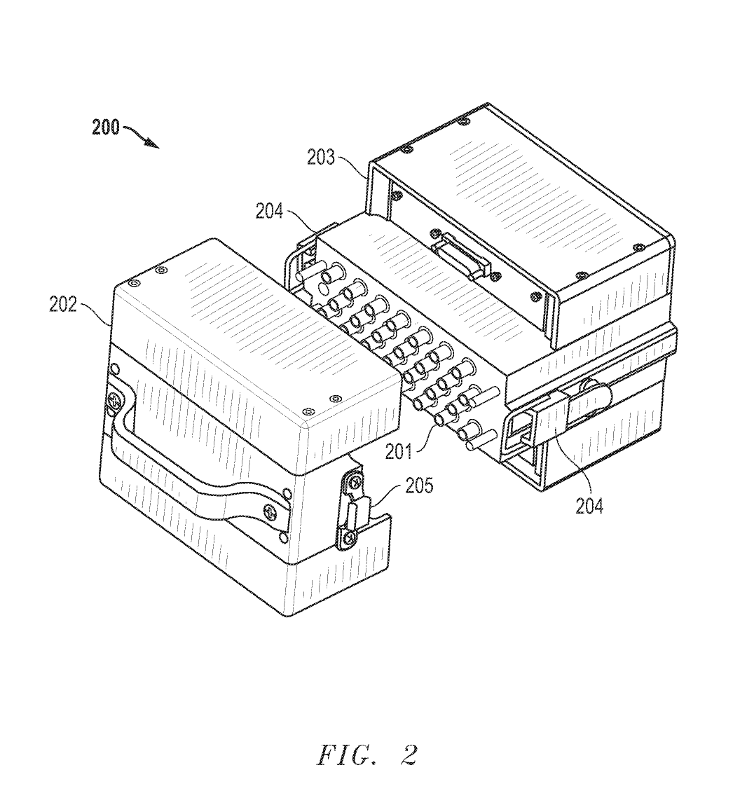

As can be seen from the foregoing description and the detail that follows, the apparatus of the present invention includes numerous features that either alone or in combination with other aspects of the present invention were not previously known in the art. For example, the device can be configured with two independent flow paths with controls and pumps that allow collection of traditional or distributed volume duplicates. The independent flow paths can sample at the same flow rate or at different flow rates. In one embodiment, including the embodiment shown in FIG. 2, twenty-eight discrete independently sealed sorbent tubes are arranged in the manifold. This configuration provides a sample density of approximately 1.47 cubic inches per sample (total manifold volume divided by 28) using tubes commonly found in the industry. The device can be fully programmable for sample start/stop time, duration, and flow rate. Types of data collected may include, for example, manifold/tube location, collection times, flow rates, and total volume collected.

In practice, it may be desirable to seal the manifold at the factory to preserve the integrity of the data being collected. A tamper proof seal may also be utilized to provide verification that the manifold has not been manipulated. The manifold can be configured in such a manner that it is interchangeable with other samplers, triggers and the like. As previously described, the device can also be configured to operate on AC power, battery power, solar power or other available power sources known in the art.

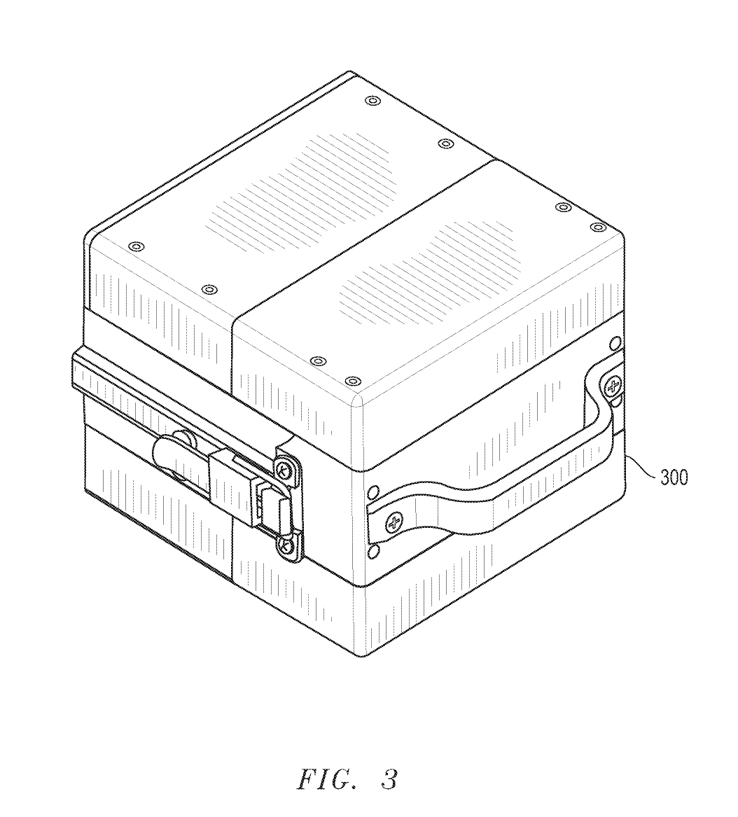

Reference is now made to FIG. 3, which shows a perspective view of one embodiment of a sampler assembly 200 of the present invention with a cover 202 attached. In this embodiment, the sampler assembly 200 is 7.38 inches by 6.59 inches by 4.35 inches, including the width of its handle 300.

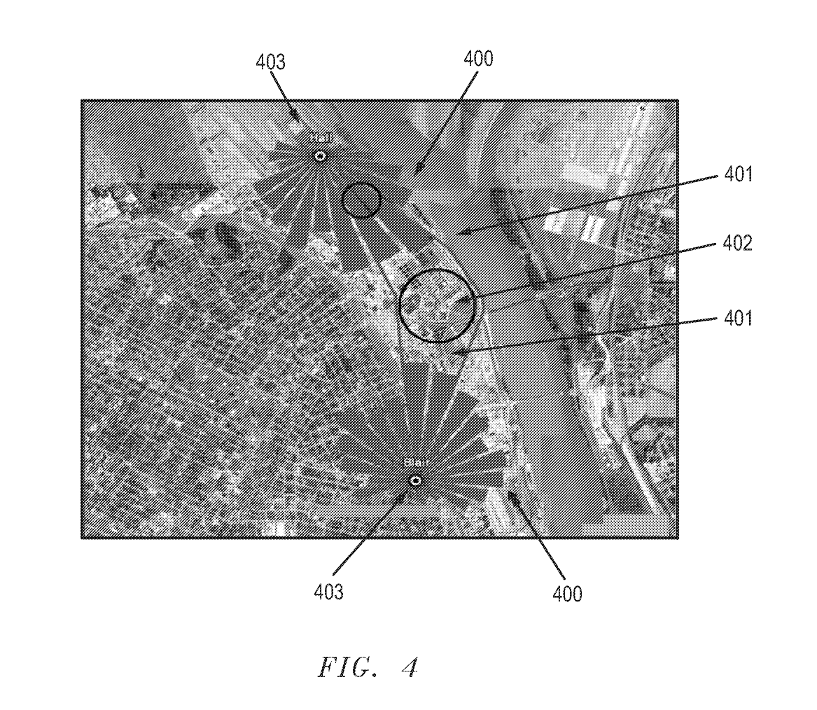

Reference is now made to FIG. 4, which shows an example of source attribution generated with one embodiment of the system 100 of the present invention. In this example, monitoring data, specifically concentration frequency collected from two systems 100 placed at different locations 403, is graphically depicted in a “wind rose” type diagram 400, with chemical concentration and wind direction mapped in circular coordinates. FIG. 4 illustrates that, although monitoring at one location can infer the direction of the source of the highest chemical concentrations found in air samples, data from two or more monitoring locations 403 can indicate the apparent location of the source. The longest arms 401 of each wind rose diagram 400 point to the same general area 402, indicating a probable source location for the highest chemical concentrations.

The system may also assess contaminant vapor intrusion in a building or other structure. Since both seasonal and diurnal variability can affect measurement programs in such environments, the system 100 provides the flexibility required to address both temporal and spatial incongruities inherent in monitoring this phenomenon. For example, the system 100 allows for a frequent sampling interval rather than a single snapshot assessment method, which typically is not a reliable source predictor in contaminant vapor intrusion assessments.

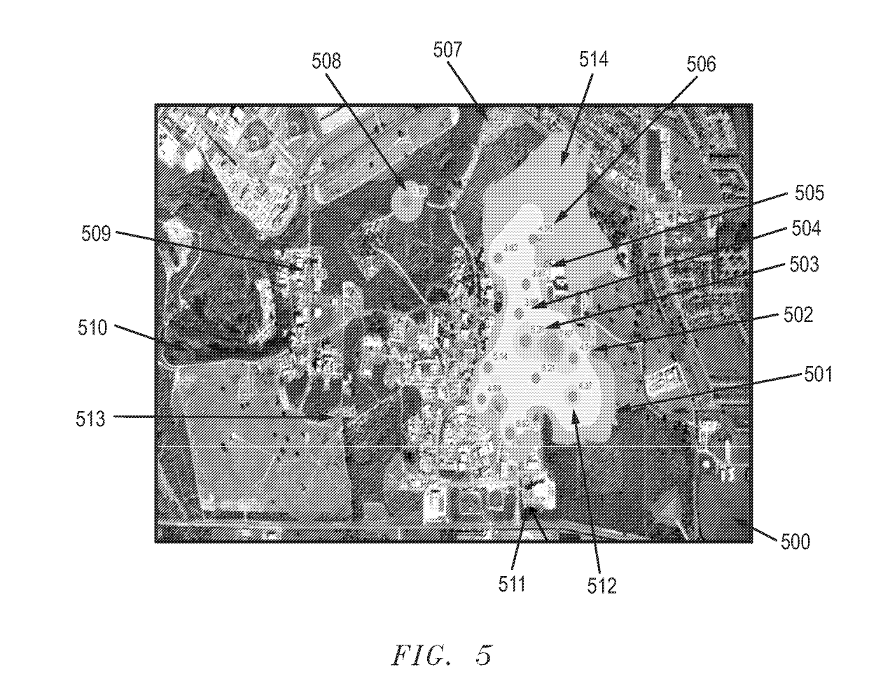

Reference is now made to FIG. 5, which shows an example map of multiple chemical parameters generated with one embodiment of the system of the present invention. In this example, systems 100 were placed at thirteen different locations 500-512 to create a dense network of systems 100. The concentration of a contaminant, ethyl acetate in this example, was measured at each location 500-512 over time, along with wind direction and speed 513. The resulting concentrations are illustrated in the form of an iso-concentration map showing different levels of shading 514 for various contaminant concentrations ranges. Similarly, a network of the systems may also coincidently monitor and map the concentration of multiple constituents over time. Such data may be viewed in a multi-dimensional model incorporating multiple chemical constituents with geographical and temporal complexity, such as those found in an urban area.

The system 100, by coupling air sampling with meteorological data collection, may also provide monitoring for chemical leak or emission source attribution. For example, the system may record chemical concentration data, wind speed, and wind direction at a relatively high temporal sampling resolution (such as at a one hour interval) and calculate the apparent source location and emission rate of multiple chemical species.

The system 100 is also well suited to support initiatives such as the EPA's 2009 study of outdoor air quality at schools in urban areas. For example, the system may eliminate sampling errors and lost data, while increasing the number of samples collected over a monitoring given period. In one embodiment, the system 100 may also meet EPA Method TO-17.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible methods and systems for environmental sampling, the detailed embodiments are intended to be illustrative only and should not be taken as limiting the scope of the invention. Rather, what is claimed as the invention includes all such modifications as may come within the spirit and scope of the following claims and equivalents thereto.

None of the descriptions in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A device capable of collecting air samples comprising:
a data acquisition and control system,
a first sample manifold capable of containing sorbent tubes, and
a second sample manifold capable of containing sorbent tubes,
said first sample manifold may be connected to said data acquisition and control system by inserting said first sample manifold into said data acquisition and control system, and
said first sample manifold may be disconnected from said data acquisition and control system and said second sample manifold may be connected to said data acquisition and control system by inserting said second sample manifold into said data acquisition and control system.

2. The device of claim 1 wherein said first sample manifold includes at least twenty-eight discrete sorbent tubes.

3. The device of claim 1 wherein said sorbent tubes may collect multiple constituents in air each capable of different flowrates.

4. The device of claim 1 wherein said manifold is configured with two independent flow paths.

5. The device of claim 1 wherein said data acquisition and control system may measure wind speed and direction.

6. The device of claim 1 wherein said data acquisition and control system may measure chemical concentration or presence.

7. The device of claim 1 wherein said data acquisition and control system may be programmed to collect a sample at a scheduled or a triggered event.

8. The device of claim 1 wherein said data acquisition and control system may collect air samples at a frequency determined by a user.

9. The device of claim 1 wherein said data acquisition and control system may communicate with at least one other data acquisition and control system.

10. The device of claim 1 wherein said data acquisition and control system may interface and operate with more than one type of sensor.

11. The device of claim 1 wherein said data acquisition and control system may operate in a low powered mode that allows said data acquisition and control system to be powered by solar power.

12. The device of claim 1 wherein said data acquisition and control system may operate in a low powered mode that allows said data acquisition and control system to be powered by battery power.

13. The device of claim 1 wherein said first sample manifold includes a connector for electronically connecting said first sample manifold to said data acquisition and control system.

14. The device of claim 1 further comprising a cover that fits onto said first sample manifold.

15. The device of claim 1 further comprising a tamper proof seal that may be utilized to provide verification that the manifold has not been manipulated.

16. The device of claim 1 wherein said data acquisition and control system manifold can be configured in such a manner that it is interchangeable with other samplers, triggers and the like.

17. The device of claim 1 wherein the manifold has no discrete pneumatic or electronic connections, thereby simplifying the process by which the operator swaps manifolds.

18. A method for collecting air samples comprising:
connecting a first sample manifold to a data acquisition and control system by inserting said first sample manifold into said data acquisition and control system,
disconnecting said first sample manifold from said data acquisition and control system, and
connecting a second sample manifold to said data acquisition and control system by inserting said second sample manifold into said data acquisition and control system,
said first sample manifold and said second manifold being capable of containing sorbent tubes.

19. The method of claim 18 wherein said first sample manifold includes at least twenty-eight discrete sorbent tubes.

20. The method of claim 18 wherein said sorbent tubes may collect multiple constituents in air.

21. The method of claim 18 wherein said manifold is configured with two independent flow paths each at a different flowrate.

22. The method of claim 18 wherein said sorbent tubes may measure wind speed and direction.

23. The method of claim 18 wherein said data acquisition and control system may be programmed to collect a sample at a scheduled or a triggered event.

24. The method of claim 18 wherein said data acquisition and control system may collect air samples at a frequency determined by a user.

25. The method of claim 18 wherein said data acquisition and control system may communicate with at least one other data acquisition and control system.

26. The method of claim 18 wherein said data acquisition and control system may interface and operate with more than one type of sensor.

27. The method of claim 18 wherein said data acquisition and control system may operate in a low powered mode that allows said data acquisition and control system to be powered by solar power.

28. The method of claim 18 wherein said data acquisition and control system may operate in a low powered mode that allows said data acquisition and control system to be powered by battery power.

29. The method of claim 18 wherein said first sample manifold includes a connector for electronically connecting said first sample manifold to said data acquisition and control system.

30. The method of claim 18 wherein said second sample manifold includes a cover that fits onto said first sample manifold.
